(19) United States
(12) Patent Application Publication
(10) Pub. No.: US 2023/0151205 A1
(43) Pub. Date: May 18, 2023

(54) RESIN COMPOSITION, EMITTER, AND TUBE FOR DRIP IRRIGATION

(71) Applicant: Enplas Corporation, Kawaguchi-shi, Saitama (JP)

(72) Inventors: Yihua Shen, Saitama (JP); Yuki Taguchi, Saitama (JP); Takahito Nagao, Saitama (JP)

(21) Appl. No.: 17/919,549

(22) PCT Filed: Apr. 7, 2021
(86) PCT No.: PCT/JP2021/014774

§ 371 Date: Oct. 18, 2022

(30) Foreign Application Priority Data
Apr. 24, 2020 (JP) 2020-077697

(51) Int. Cl. C08L 67/02; C08K 5/527; A01G 25/02

(52) U.S. Cl. CPC C08L 67/02; C08K 5/527; A01G 25/023; C08L 2205/025; A01G 2025/006

(57) ABSTRACT

The problem of the present invention is to provide a biodegradable resin composition that can be easily molded in a short time, with molded bodies therefrom having appropriate flexibility. The resin composition for solving the above problem comprises 100 parts by mass of poly(butylene adipate/terephthalate) and 1-10 parts by mass of an aliphatic polyester having a certain structure. The amount of the poly(butylene adipate/terephthalate) is 80% by mass or more based on the total amount.

### TECHNICAL FIELD

The present invention relates to a resin composition, an emitter, and a drip irrigation tube.

### BACKGROUND ART

In recent years, environmental pollution caused by plastics has become a problem, which leads to the increase of the demand for resin compositions that mainly contain biodegradable resins. Such resin compositions have attracted attention particularly in the fields of, for example, agricultural films and packaging containers. As a method for processing a resin composition into various shapes, molding such as injection molding is commonly used.

In a commonly used injection molding method, a resin composition is heated to a temperature higher than the melting point of the resin, and the resin composition with increased fluidity is poured into a mold. Subsequently, the resin composition is cooled to a temperature below the crystallization temperature of the resin to solidify the resin composition. However, poly(butylene adipate/terephthalate) (namely, (poly(butylene adipate-co-terephthalate), hereinafter also referred to as “PBAT”), which is known as a biodegradable resin, has a slow crystallization rate. Therefore, for processing a resin composition containing PBAT into a desired shape, a substantially long time is required between the procedures, namely pouring the resin composition into the mold, and removing the resin composition from the mold (hereinafter also referred to as “molding cycle time”).

With respect to the above disadvantages, a resin composition including PBAT with a metal salt of a phosphate (herein also referred to as “phosphate metal salt”), fatty acid sodium salt, talc, and/or the like added thereto is proposed (Patent Literature (hereinafter, referred to as PTL) 1). PTL 1 teaches that the phosphate metal salt and the like increases the crystallinity of the resin composition.

A resin composition including PBAT with polylactic acid (hereinafter also referred to as “PLA”) and an adipic acid-based plasticizer added thereto is also proposed (PTL 2). PTL 2 teaches that mixing relatively hard PLA and highly flexible PBAT can achieve both the desired flexibility and high impact strength.

In addition, a resin composition containing PBAT and thermoplastic starch is proposed (Non Patent Literature (hereinafter, referred to as NPL) 1). The technique of NPL 1 is supposed to improve moldability by adding the thermoplastic starch.

### CITATION LIST

### Patent Literature

PTL 1
Japanese Patent Application Laid-Open No. 2013-133364
PTL 2
Japanese Patent Application Laid-Open No. 2014-5435

### Non Patent Literature

NPL 1
Seligra P. G., et al., “Influence of incorporation of starch nanoparticles in PBAT/TPS composite films,” PolymInt, Vol. 65, pp. 938-945

### SUMMARY OF INVENTION

### Technical Problem

Addition of the phosphate metal salt, talc, and the like to PBAT as in PLT 1 tends to lower the fluidity during injection molding, thereby making the molding of the resin composition difficult. In addition, the molded article of the resin composition of PLT 2 tends to have increased hardness due to PLA, and thus the flexibility derived from PBAT cannot be fully exhibited. It is also difficult to shorten the time required for injection molding (molding cycle time) with the use of this resin composition.

Further, regarding the technique described in NPL 1, the compatibility between PBAT and the thermoplastic starch is poor, which not only impairs the inherent flexibility of PBAT, but also lowers moldability. From the foregoing, there is a demand for a resin composition that is biodegradable, has excellent moldability, and can provide a molded product having appropriate flexibility.

An object of the present invention is to provide a resin composition that is biodegradable, can be easily molded in a short time, and can provide a molded article having appropriate flexibility. Another object of the present invention is to provide an emitter and a drip irrigation tube each containing the resin composition.

### Solution to Problem

To achieve the above object, the present invention provides the following resin composition.

A resin composition containing 100 parts by mass of poly(butylene adipate/terephthalate) and 1 to 10 parts by mass of an aliphatic polyester represented by the following general formula 1:

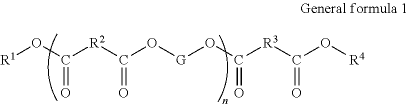

where R¹ and R⁴ each represent an alkyl group having 1 to 12 carbon atoms, R² and R³ each represent an alkyl group having 2 to 5 carbon atoms, G represents an alkyl group having 2 to 12 carbon atoms, and n represents an integer of 2 to 10, and the amount of poly(butylene adipate/terephthalate) is 80 mass % or more based on the total mass of the resin composition.

The present invention also provides the following emitter.

An emitter for discharging an irrigation liquid in a tube, which allows the irrigation liquid to flow therethrough, at a constant rate from a discharge port, which allows an inside and the outside of the tube to communicate with each other, to an outside of the tube when the emitter is joined to an inner wall surface of the tube at a position corresponding to the discharge port, and the emitter includes an intake part for taking the irrigation liquid into the emitter, a discharge part for discharging the irrigation liquid to the discharge port, and a channel connecting the intake part and the discharge part, and the emitter contains the above-described resin composition.

The present invention also provides the following drip irrigation tube.

A drip irrigation tube including a tube and the above-described emitter disposed in the tube.

### Advantageous Effects of Invention

A resin composition according to the present invention is biodegradable and can be efficiently molded in a short time. In addition, a resulting molded article from the resin composition has high flexibility. Therefore, the resin composition is applicable to various uses such as tubes for drip irrigation and emitters used therefor.

### BRIEF DESCRIPTION OF DRAWINGS

FIG. 1 is a cross-sectional view illustrating an exemplary drip irrigation tube obtained from the resin composition of the present invention;

FIG. 2A is a plan view of an emitter in the drip irrigation tube illustrated in FIG. 1, FIG. 2B is a bottom view of the emitter, FIG. 2C is a left side view of the emitter, and FIG. 2D is a right side view of the emitter;

FIG. 3 is a cross-sectional view taken along line A-A of FIG. 2A; and

FIG. 4A is a bottom view of the emitter illustrated in FIGS. 2A to 2D before assembly, FIG. 4B is a plan view of the emitter before assembly, and FIG. 4C is a cross-sectional view taken along line A-A of FIG. 4A.

### DESCRIPTION OF EMBODIMENTS

Hereinafter, the resin composition will be described in detail, and an emitter and a tube each containing the resin composition will then be described.

1. Resin Composition

A resin composition of the present invention contains poly(butylene adipate/terephthalate) (PBAT) and an aliphatic polyester having a specific structure. The amount of poly(butylene adipate/terephthalate) in the resin composition is 80 mass % or more.

As described above, it is difficult for a conventional resin composition containing PBAT to achieve both high fluidity during molding and a high crystallization temperature. In addition, there is another disadvantage such that addition of a crystal nucleating agent or the like for improving moldability lowers the flexibility of the resulting molded article.

The present inventors have found that adding an aliphatic polyester having a specific structure together with PBAT to a resin composition can lower the melt viscosity of the resin composition, and increase the crystallization temperature of the resin composition. These component allows the resin composition of the present invention to efficiently produce molded articles in a short molding cycle. In other words, the resin composition can be molded without any addition of other materials such as a hard resin (such as PLA) or a crystal nucleating agent. The aliphatic polyester does not lower the flexibility of the resulting molded article. Therefore, the resulting molded article has appropriate flexibility derived from PBAT. Such a resin composition is also applicable to molding materials of, for example, emitters that adjust the flow rate with, for example, a diaphragm in drip irrigation tubes.

In the following, components of the resin composition of the present invention will be described. The resin composition of the present invention may contain components in addition to PBAT and the aliphatic polyester. Examples of the additional components include aliphatic ester compounds and metal phosphates.

Poly(Butylene Adipate/Terephthalate) (PBAT)

PBAT is a biodegradable resin. In the resin composition of the present invention, PBAT is the main component occupying 80% or more of the total amount of the resin composition. The content of PBAT is preferably 85 to 99 mass %, more preferably 90 to 99 mass %, based on the total amount of the resin composition. Content of PBAT within this range allows obtainment of a resin composition having desired flexibility and satisfactory process ability.

PBAT is a polymer obtained by condensation polymerization of adipic acid, terephthalic acid, and 1,4-butanediol. The amount of structural units derived from adipic acid in PBAT is preferably about 10 to 50 mol %, more preferably 15 to 40 mol %, based on the total amount of structural units constituting PBAT. The amount of structural units derived from terephthalic acid is preferably about 5 to 45 mol %, more preferably 8 to 35 mol %, based on the total amount of structural units constituting PBAT. The amount of structural units derived from 1,4-butanediol is preferably about 5 to 45 mol %, more preferably 10 to 30 mol %.

In addition to the structural units derived from adipic acid, terephthalic acid, and 1,4-butanediol, PBAT may partially contain structural units derived from additional components, so long as the objects and effects of the present invention are not impaired. Examples of the additional components include dihydroxy compounds such as diethylene glycol, triethylene glycol, polyethylene glycol, polypropylene glycol, and polytetrahydrofuran; and hydroxycarboxylic acids such as glycolic acid, D-lactic acid, L-lactic acid, D,L-lactic acid, 6-hydroxyhexanoic acid, glycolide (1,4-dioxane-2,5-dione), D-dilactide (3,6-dimethyl-1,4-dioxane-2,5-dione), L-dilactide (3,6-dimethyl-1,4-dioxane-2,5-dione), and p-hydroxybenzoic acid. The amount of structural units derived from these additional components is preferably 30 mol % or less based on the total amount of structural units constituting PBAT.

The weight average molecular weight of PBAT is appropriately selected according to the application and molding temperature of the resin composition, and is preferably 3,000 to 1,000,000, more preferably 20,000 to 600,000, and even more preferably 50,000 to 400,000. The weight average molecular weight of PBAT is a value measured by gel permeation chromatography (GPC) in terms of standard polystyrene. A weight average molecular weight of PBAT within this range facilitates the adjustment of the fluidity to fall within a desired range during molding of the resin composition.

The viscosity of PBAT measured with a capillary rheometer at 200° C. and at a shear rate of 20 s⁻¹ is preferably 1,000 to 3,000 Pa·s, more preferably 1,200 to 2,500 Pa·s. A viscosity within this range facilitates the adjustment of the viscosity of the resin composition to fall within a desired range, thereby facilitating the processing of the resin composition by, for example, injection molding.

PBAT may be prepared by polymerizing the above components, or may be a commercially available product. An example of the commercially available PBAT is Ecoflex manufactured by BASF.

Aliphatic Polyester

The aliphatic polyester is a polyester resin having a specific structure described below. A resin composition containing the aliphatic polyester has an increased melt viscosity, and can be cured (crystallized) at a relatively high temperature.

The amount of the aliphatic polyester is preferably 0.5 to 9 mass %, more preferably 1 to 8 mass %, based on the total amount of the resin composition. The amount of the aliphatic polyester based on 100 parts by mass of PBAT is 1 to 10 parts by mass, preferably 1 to 9 parts by mass, more preferably 2 to 8 parts by mass. An amount of the aliphatic polyester of 1 part by mass or more can improve the fluidity of a resin composition even at a relatively low temperature. An amount of the aliphatic polyester of 10 part by mass or more can lower the crystallization temperature of a resin composition, but may cause bleed-out in the resulting molded article. When the amount of the aliphatic polyester is within the above range, the resulting molded article has appropriate flexibility and thus can be applied to applications that require elasticity.

Adjusting the amount of the aliphatic polyester to fall within the above range can improve the moldability of the resin composition without lowering the inherent flexibility of PBAT.

The aliphatic polyester is a polymer represented by the following general formula 1.

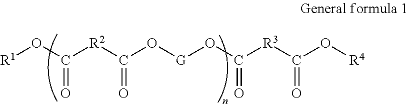

In the general formula, R¹ and R⁴ each independently represent an alkyl group having 1 to 12 carbon atoms. The number of carbon atoms of each of R¹ and R⁴ is more preferably 3 to 11, even more preferably 5 to 10. R¹ and R⁴ may be linear or branched. R¹ and R⁴ may be the same or different to each other.

In the general formula, R² and R³ each independently represent an alkyl group having 2 to 5 carbon atoms. Typically, R² and R³ are structures derived from dicarboxylic acids. When the number of carbon atoms of R² and R³ is 2 to 5, the affinity between the aliphatic polyester and the above-described PBAT is increased, the melt viscosity of the resin composition is more likely to be lowered, and PBAT is more likely to be crystallized. R² and R³ may be branched, but are more preferably linear. R² and R³ may be different to each other, but usually are the same structure. R² and R³ particularly preferably has 4 carbon atoms, namely a structure derived from adipic acid.

In the general formula, G represents an alkyl group having 2 to 12 carbon atoms and usually is a diol-derived structure. The number of carbon atoms of G is preferably 2 to 10, more preferably 3 to 8. G may be linear or branched. When the number of carbon atoms of G is within the above range, the affinity between the above-described PBAT and the aliphatic polyester is more likely to increase.

In the general formula, n represents an integer of 2 to 10, preferably 2 to 9, and more preferably 2 to 8. The number represented by n can be adjusted according to, for example, the viscosity of the aliphatic polyester. The viscosity of the aliphatic polyester measured at 25° C. at an angular frequency of 1 Hz with the use of an coaxial double-cylinder rotational viscometer is preferably 100 to 10,000 mPa·s, more preferably 300 to 5,000 mPa·s. A viscosity of the aliphatic polyester within this range facilitates the adjustment of the viscosity of the resin composition to fall within a desired range.

The weight average molecular weight of the aliphatic polyester is preferably 400 to 8,000, more preferably 500 to 5,000, even more preferably 800 to 3,000. A weight average molecular weight of the aliphatic polyester within this range facilitates the adjustment of the viscosity of the aliphatic polyester to fall within a desired range, thereby facilitating the mixing with PBAT. The weight average molecular weight of the aliphatic polyester is a value measured by gel permeation chromatography (GPC) in terms of standard polystyrene.

The aliphatic polyester can be prepared, for example, by polymerizing a dicarboxylic acid and a diol by a known method. Examples of the dicarboxylic acid used in the preparation include glutaric acid, adipic acid, and pimelic acid. Examples of the diol used in the preparation include ethylene glycol, 1,2-propanediol, 1,3-propanediol, 2-methyl-1,3-propanediol, 2,2-dimethyl-1,3-propanediol, 2,2-diethyl-1,3-propanediol, 1,2-butanediol, 1,3-butanediol, 1,4-butanediol, 1,5-pentanediol, 1,5-hexanediol, 1,6-hexanediol, 3-methyl-1,5-pentanediol, 2-ethyl-1,3-hexanediol, 2,2,4-trimethyl-1,3-pentanediol, 1,7-heptanediol, 1,8-octanediol, and 1,2-octanediol.

Aliphatic Ester Compound

The resin composition may further contain an aliphatic ester compound having a structure derived from a fatty acid having 2 to 5 carbon atoms. An aliphatic ester compound herein is a low-molecular-weight ester compound having two or less ester bonds per molecule. Examples of the aliphatic ester compound include reaction products of dicarboxylic acids each having alkyl group of 2 to 5 carbon atoms with monohydric alcohols.

When the resin composition contains the aliphatic ester compound, the aliphatic ester compound functions as a crystallization accelerator, more likely to increase the crystallization temperature of the resin composition. An excessive amount of the aliphatic ester compound may impair the flexibility of the resulting molded article. Therefore, the amount of the aliphatic ester compound is preferably 5 parts by mass or less, more preferably 0.1 to 4 parts by mass, based on 100 parts by mass of PBAT. When the amount of the aliphatic ester compound is within this range, the resulting molded article is less likely to be excessively hard.

The aliphatic ester compound preferably has a structure derived from glutaric acid, adipic acid, or pimelic acid, and particularly preferably has a structure derived from adipic acid. When the aliphatic ester compound has a structure derived from adipic acid, the affinity between the above-described PBAT and the aliphatic ester compound becomes excellent, allowing the aliphatic ester compound to promote crystallization of PBAT.

Examples of the alcohols to be reacted with adipic acid and the like include linear or branched monohydric alcohols having 2 to 12 carbon atoms. Examples of the monohydric alcohols include ethanol, butanol, isobutyl alcohol, isononyl alcohol, isodecyl alcohol, 2-ethylhexanol, n-octanol, n-decyl alcohol, and butyl diglycol.

The molecular weight of the aliphatic ester compound is preferably 150 to 500, more preferably 200 to 450, even more preferably 250 to 400. A molecular weight of the aliphatic ester compound within this range can improve the crystallinity of the resin composition.

Phosphate Metal Salt

The resin composition may further contain a phosphate metal salt having a specific structure. The phosphate metal salt functions as a crystal nucleating agent; thus a resin composition containing the phosphate metal salt has a high crystallization temperature.

An excessive amount of the phosphate metal salt may lower the flexibility of the resulting molded article. Therefore, the amount of the phosphate metal salt is preferably 5 parts by mass or less, more preferably 0.1 to 2 parts by mass, based on 100 parts by mass of PBAT. When the amount of the phosphate metal salt is within this range, the resulting molded article is less likely to be excessively hard.

The phosphate metal salt is represented by the following general formula 2.

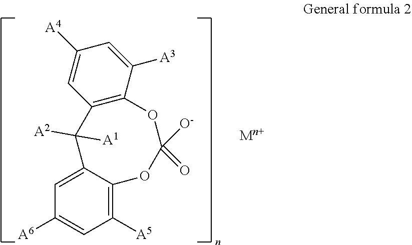

In the general formula, A¹ and A² each independently represent a hydrogen atom or an alkyl group having 1 to 4 carbon atoms. A¹ and A² may be the same or different to each other. In the general formula, A³ to A⁶ each independently represent an alkyl group having 1 to 12 carbon atoms. A³ to A⁶ may be the same or different to each other. A¹ to A⁶ may be linear or branched.

M represents at least one metal atom selected from the group consisting of alkali metal atoms, alkaline earth metal atoms, and transition metal atoms. Examples of M include Li, Na, K, Al, Mg, and Ca, with Li, Na, Al being more preferred. In the general formula, n represents 1 or 2.

Additional Components

The resin composition may contain components in addition to the above described components, so long as the objects and effects of the present invention are not impaired. Examples of the additional components include ultraviolet absorbers and antioxidants for the purpose of preventing deterioration.

Methods for Preparing and Molding Resin Composition

The above described resin composition can be prepared, for example, by mixing components such as PBAT, an aliphatic polyester, an aliphatic ester compound, and a phosphate metal salt, and kneading the mixture by a known method.

The melt viscosity of the resin composition at 200° C. is preferably 300 to 1,500 Pa·s, more preferably 500 to 1,200 Pa·s. A melt viscosity of the resin composition within this range can increase the fluidity, allowing easy application of the resin composition for the production of molded products having a fine structure, such as an emitter of a drip irrigation tube described below. The melt viscosity is measured with a capillary rheometer at a shear rate of 20 s⁻¹.

The crystallization temperature of the resin composition is preferably 50 to 95° C., more preferably 60 to 85° C. A crystallization temperature within this range allows the resin composition to be cured in a relatively short time, thereby shortening the cycle time during the molding. The crystallization temperature is measured by a differential scanning calorimeter. Specifically, the crystallization temperature is the value observed as the peak top of exotherm during the cooling procedure in a chart obtained by heating the resin composition from room temperature to 200° C. at a rate of 10° C./min, holding the temperature at 200° C. for 5 minutes, and then cooling the resin composition to −50° C. at a rate of −10° C./min.

Any known molding method can be used for molding the resin composition. Examples of the molding methods include injection molding, extrusion molding, blow molding, compression molding, transfer molding, and calendar molding. In particular, injection molding is preferred. The injection molding may be of any type, such as insert molding, gas-assisted injection molding, or injection compression molding.

2. Drip Irrigation Tube (Emitter and Tube)

The resin composition of the present invention may be used in any application that requires biodegradability, for example, for emitters and tubes of drip irrigation tubes. Biodegradable emitter and tube can be buried in soil or composted when they are no longer needed, thus can be treated without imposing a burden on the environment. However, applications of the resin composition are not limited to emitters and tubes. In addition, an emitter can be formed, for example, by injection molding the resin composition described above, and a tube can be formed, for example, by extrusion molding the resin composition described above.

Hereinafter, an exemplary drip irrigation tube (emitter and tube) to which the resin composition of the present invention can be applied will be described with reference to the drawings. However, the emitter and tube of the present invention are not limited to the structures described below.

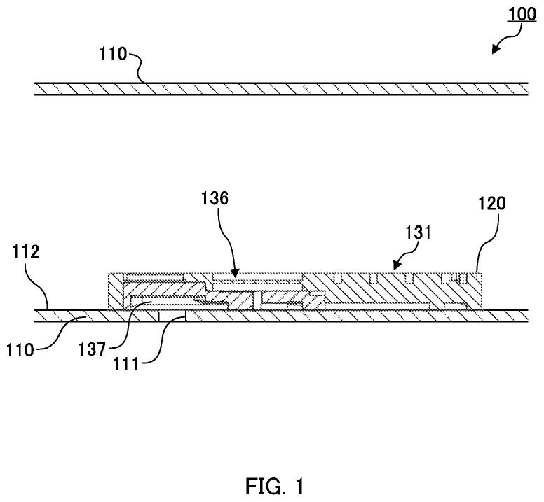

FIG. 1 is a cross-sectional view of drip irrigation tube 100. As illustrates in FIG. 1, drip irrigation tube 100 includes tube 110 and one or more emitters 120. The resin composition may be applied to both tube 110 and emitter 120. Examples of irrigation liquids flowing through tube 110 include water, liquid fertilizers, pesticides, and mixtures thereof.

Tube 110 is a pipe for allowing an irrigation liquid to flow therethrough. Tube 110 includes plurality of discharge ports 111 for discharging the irrigation liquid, at predetermined intervals (for example, 200 mm or more and 500 mm or less) along the axial direction of the tube. The opening of discharge port 111 of tube 110 may have any diameter, so long as the irrigation liquid can be discharged therefrom. In the embodiment illustrated in FIG. 1, the diameter of the opening of discharge port 111 is 1.5 mm Tube 110 may have any cross-sectional shape and cross-sectional area perpendicular to the axial direction of the tube, so long as emitter 120 can be disposed inside tube 110.

Emitter 120 is a member to be joined to inner wall surface 112 of tube 110 at a position corresponding to discharge port 111. Emitter 120 is a member for adjusting the discharge amount of irrigation liquid from drip irrigation tube 100. Tube 110 and emitter 120 may be joined by any method, and may be welded or joined with an adhesive.

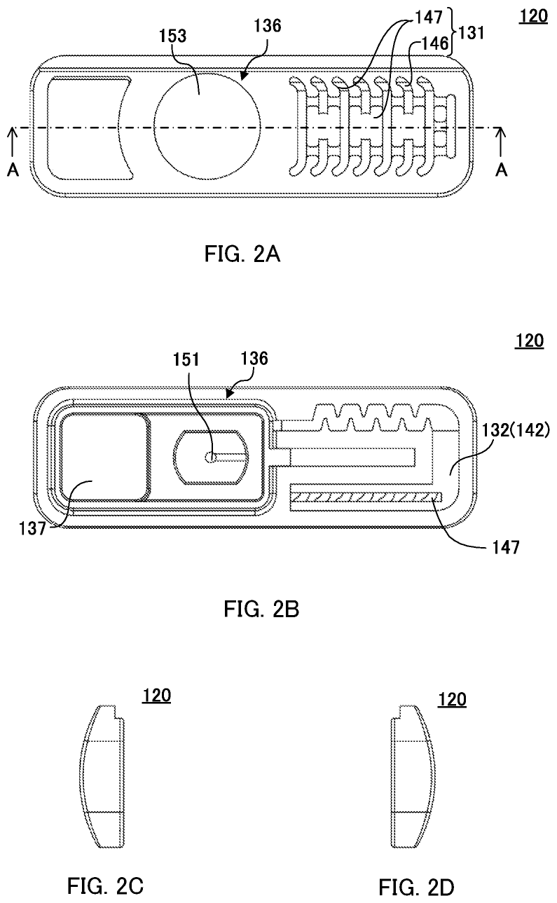

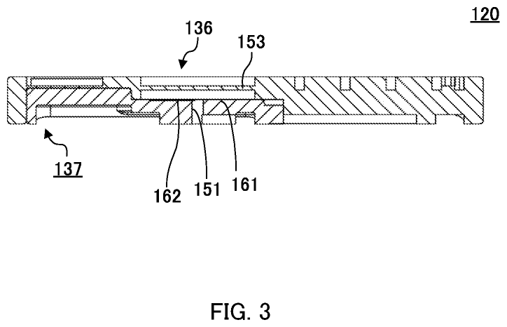

FIG. 2A is a plan view of emitter 120 and FIG. 2B is a bottom view of emitter 120. FIG. 2C is a left side view of the emitter, and FIG. 2D is a right side view of the emitter. FIG. 3 is a cross-sectional view taken along line A-A of FIG. 2A.

As illustrated in FIGS. 2A to 2D, emitter 120 has a substantially rectangular shape with rounded corners. Emitter 120 may have any size, which may be appropriately determined based on the desired amount of irrigation liquid to be discharged from discharge port 111. In the present embodiment, emitter 120 has a long side length of 19 mm, a short side length of 8 mm, and a height of 2.7 mm.

Emitter 120 includes intake part 131, discharge part 137, and groove 132 (channel 142) connecting intake part 131 with discharge part 137. Intake part 131 is for taking in irrigation liquid from the tube 110 side. Discharge part 137, disposed at a position corresponding to discharge port 111 of tube 110, is for discharging the irrigation liquid to discharge port 111 of tube 110. In the present embodiment, emitter 120 further includes flow rate adjusting part 136 between channel 142 and discharge part 137.

Intake part 131 is a structure for taking irrigation liquid into emitter 120. Intake part 131 is disposed in emitter 120 on the surface side (the side closer to the center of the axial direction of tube 110). Intake part 131 includes intake side screen part 146 and intake through hole 147. Intake side screen part 146 is a structure for preventing floating matter in the irrigation liquid from entering intake through hole 147.

As illustrated in FIG. 2B, groove 132 is disposed in emitter 120 on the back side (on the side of the inner wall surface 112 of tube 110). The region surrounded by groove 132 and tube 110 serves as channel 142 for the irrigation liquid. Groove 132 may have any shape, so long as groove 132 connects intake through hole 147 of intake part 131 with flow rate adjusting part 136. The shape of groove 132 may be straight, curved, or zigzag. In the present embodiment, a straight groove and a zigzag groove are combined. The zigzag region can reduce the pressure of the irrigation liquid taken from intake part 131.

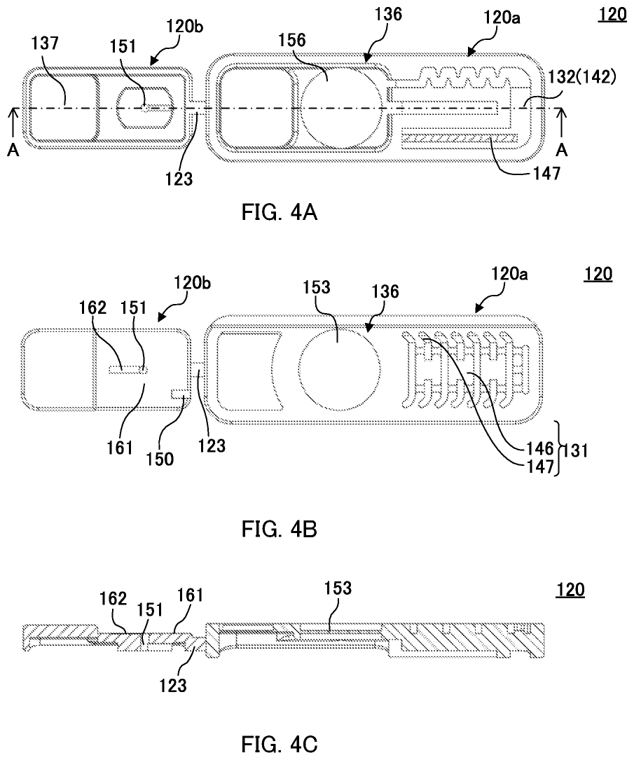

Flow rate adjusting part 136 is a structure for adjusting the discharge amount of the irrigation liquid that has been taken into emitter 120. As illustrated in FIG. 3, flow rate adjusting part 136 includes base 161, diaphragm part 153, communication hole 151, communicating groove 162, and notched groove 150 (see FIG. 4B). In flow rate adjusting part 136, diaphragm part 153 faces base 161, communication hole 151 connects the surface of base 161 with the back side of the emitter 120, communicating groove 162 is disposed in base 161, and notched groove 150 is for taking in the irrigation liquid from groove 132 (channel 142) toward flow rate adjusting part 136 (toward an area between base 161 and diaphragm part 153). In flow rate adjusting part 136, the irrigation liquid is taken into the area between base 161 and diaphragm part 153 via notched groove 150 and allowed to flow toward discharge part 137 via communication hole 151.

Emitter 120 including such flow rate adjusting part 136 is formed of first main body 120a and second main body 120b. For easy understanding of the structure of flow rate adjusting part 136, FIGS. 4A to 4C illustrate a structure of emitter 120 before assembling, namely the structures of first main body 120a and second main body 120b. FIG. 4A illustrates the back side structures of first main body 120a and second main body 120b and FIG. 4B illustrates the front side structures of first main body 120a and second main body 120b. FIG. 4C is a cross-sectional view taken along line A-A of FIG. 4A. For producing emitter 120, first main body 120a and second main body 120b are separated from each other at hinge 123 that connects the bodies, and then second main body 120b is fitted to the back side of first main body 120a. At this time, first main body 120a and second main body 120b are fitted to each other in such a way that base 161 faces diaphragm part 153.

Notched groove 150 is used to appropriately guide the irrigation liquid introduced from groove 132 (channel 142) to the area between base 161 and diaphragm part 153. Notched groove 150 may have any shape, so long as the above function can be exhibited. In the present embodiment, notched groove 150 is formed in a straight line.

Base 161 is a region where diaphragm part 153 contacts when diaphragm part 153 is deformed by the pressure of the irrigation liquid. Base 161 may have any shape. Base 161 may have a shape of a curved or flat surface. In the present embodiment, base 161 has a shape of a flat surface. Notched groove 150 is formed in a part of the flat surface where base 161 is disposed.

Communication hole 151 is used to allow the irrigation liquid having flowed into the area between base 161 and diaphragm part 153 to flow toward discharge part 137 of tube 110. In the present embodiment, communication hole 151 opens onto the central portion of base 161. The size of the opening of communication hole 151 is also not limited and can be set as appropriate.

Communicating groove 162 is for guiding the irrigation liquid to communication hole 151 even when diaphragm part 153 is bent and is in contact with base 161. One end of communicating groove 162 communicates with communication hole 151. The other end of communicating groove 162 is disposed outside the region where diaphragm part 153 is brought into contact with base 161.

Diaphragm part 153 may have any configuration so long as the diaphragm part can bend toward base 161 due to the pressure of the irrigation liquid flowing through tube 110. In the present embodiment, the shape of diaphragm part 153 in plan view is circular. In the present embodiment, diaphragm part 153 is formed integrally with other components of emitter 120 (intake part 131 and channel 142).

Discharge part 137 is a region for temporarily storing the irrigation liquid configured to flow toward the emitter 120 side via through hole 151 of flow rate adjusting part 136 described above. The irrigation liquid that has reached discharge part 137 is discharged to the outside from discharge port 111.

In emitter 120, irrigation liquid taken in from intake part 131 flows into flow rate adjusting part 136 via groove 132 (channel 142). In flow rate adjusting part 136, the irrigation liquid is taken into the area between base 161 and diaphragm part 153 via notched groove 150. When the pressure of the irrigation liquid in tube 110 is low, diaphragm part 153 of flow rate adjusting part 136 is substantially parallel with base 161, and the irrigation liquid easily flows toward discharge part 137. On the other hand, when the pressure of the irrigation liquid in tube 110 increases, diaphragm part 153 of flow rate adjusting part 136 bends toward base 161 as the material of the present invention has appropriate flexibility. As a result, the gap between diaphragm part 153 and base 161 is reduced, making it difficult for the irrigation liquid to flow from the communication hole 151 side toward discharge part 137. When the pressure of the irrigation liquid in tube 110 is very high, diaphragm part 153 is brought into close contact with base 161. That is, diaphragm part 153 covers base 161. However, even in this case, a certain amount of irrigation liquid flows into communication hole 151 via communicating groove 162.

When the pressure of the irrigation liquid flowing through tube 110 is low, the amount of irrigation liquid taken into emitter 120 would be reduced, and when the pressure of the irrigation liquid flowing through tube 110 is high, the amount of irrigation liquid taken into emitter 120 would be increased. The amount of the irrigation liquid flowing into the discharge part 137 side is adjusted by flow rate adjusting part 136 as described above in the present invention. Therefore, regardless of the pressure of the irrigation liquid in tube 110, the amount of the irrigation liquid flowing from communication hole 151 toward discharge part 137 can be kept substantially constant.

### EXAMPLES

The present invention will be described in detail based on Examples, but the present invention is not limited to these Examples.

Preparation of Materials

PBAT: product name Ecoflex C1200, manufactured by BASF

Aliphatic polyester B-1: PN7650 (adipic acid-based polyester, viscosity measured with a coaxial double-cylinder rotational viscometer at 25° C. at an angular frequency of 1 Hz: 3,000 mPa·s), manufactured by ADEKA CORPORATION

Aliphatic polyester B-2: PN7160 (adipic acid-based polyester, viscosity measured with a coaxial double-cylinder rotational viscometer at 25° C. at an angular frequency of 1 Hz: 150 mPa·s), manufactured by ADEKA CORPORATION

Aliphatic polyester B-3: D623 (adipic acid-based polyester, viscosity measured with a coaxial double-cylinder rotational viscometer at 25° C. at an angular frequency of 1 Hz: 3,000 mPa·s), manufactured by J-PLUS Co., Ltd.

Aliphatic ester compound: diisononyl adipate (viscosity measured with a coaxial double-cylinder rotational viscometer at 25° C. at an angular frequency of 1 Hz: 16 mPa·s), manufactured by FUJIFILM Wako Pure Chemical Corporation,

Phosphate metal salt: sodium 2,2′-methylenebis(4,6-di-tert-butylphenyl) phosphate, manufactured by Tokyo Chemical Industry Co., Ltd.

### Example 1

Preparation of Resin Composition

A resin composition was obtained by mixing 100 parts by mass of PBAT and 1 part by mass of aliphatic polyester B-1 and kneading the mixture at 160° C. for 5 minutes with a two-roll mill.

### Examples 2 to 13 and Comparative Examples 1 to 6

Resin compositions were prepared in the same manner as in Example 1, except that the amounts of the components were changed as shown in Tables 1 and 2.

Evaluation

For Examples and Comparative Examples, the melt viscosities of the resin compositions at 200° C., the crystallization temperatures of the resin compositions, the evaluation of the appearance of molded articles, and the presence or absence of bleed-out were observed by the following methods. Tables 1 and 2 show the results.

Measurement of Melt Viscosity of Resin Composition at 200° C.

The viscosity of each resin composition at 200° C. was measured with a capillary rheometer at a shear rate of 20 s⁻¹. The obtained melt viscosity was evaluated according to the following criteria.

Excellent: 1,200 Pa·s or less

Good: more than 1,200 Pa·s and 1,500 Pa·s or less

Poor: more than 1,500 Pa·s

Measurement of Crystallization Temperature of Resin Composition

Each resin composition was scraped to remove a thin slice with a cutter or the like. The obtained sliced sample (about 8 mg) was inserted into a pan for DSC measurement and brought into close contact with the pan. The crystallization temperature of the sample was measured by using a differential scanning calorimeter (product name DSCvesta, manufactured by Rigaku Corporation,). Specifically, the sample was heated to 200° C. at the rate of 10° C./min, held for 5 minutes, and then cooled to −50° C. at the rate of −10° C./min. In the obtained chart, the peak top of exotherm in the cooling procedure was taken as the crystallization temperature of the resin composition.

Evaluation of Appearance of Molded Article with Cycle Time of 20 Seconds

Each resin composition was introduced into an injection molding machine (product name SE30S, manufactured by Sumitomo Heavy Industries, Ltd.), heated to 200° C., and introduced into a mold at 60° C. to obtain an molded article having a structure illustrated in FIGS. 4A to 4C. After cooling for 10 seconds, the molded article was removed from the mold. The time required for injection molding (cycle time) was 20 seconds. An emitter was assembled from the molded article. The obtained emitters were evaluated for appearance visually and with a light microscope. Evaluation criteria are as follows.

Excellent: No appearance defects was found

Good: Minor sink marks or minor short shots were found

Poor: Sink marks, short shots, warping and twisting occurred, or molding was impossible

Observation of Bleed-Out from Molded Article

The emitters prepared as described above were left at room temperature for one week. Subsequently, the surface condition of each emitter was visually checked to observe the presence or absence of bleed-out. Evaluation criteria are as follows.

Excellent: No bleed-out was observed

Good: A small amount of bleed-out was observed

Poor: A large amount of bleed-out was observed

TABLE 1

| | | | Example | Example | Example | Example | Example | Example | Example | Example | Example | Example |
|---|---|---|---|---|---|---|---|---|---|---|---|---|
| | | | 1 | 2 | 3 | 4 | 5 | 6 | 7 | 8 | 9 | 10 |
| Compo- | PBAT | | 100 | 100 | 100 | 100 | 100 | 100 | 100 | 100 | 100 | 100 |
| sition | Aliphatic | B-1 | 1 | | | 5 | | | 10 | | 4 | 3 |
| (parts by | polyester | B-2 | | 1 | | | 5 | | | | | |
| mass) | | B-3 | | | 1 | | | 5 | | 10 | | |

| | | | | | | | | | | | |
|---|---|---|---|---|---|---|---|---|---|---|---|
| | Aliphatic ester | | | | | | | | | 1 | 2 |
| | compound | | | | | | | | | | |
| | Phosphate metal | | | | | | | | | | |
| | salt | | | | | | | | | | |
| Evaluation | Melt viscosity | Good | Good | Good | Excellent | Excellent | Excellent | Excellent | Excellent | Excellent | Excellent |
| | Crystallization | 69 | 69 | 69 | 70 | 70 | 70 | 69 | 70 | 71 | 71 |
| | temperature | | | | | | | | | | |
| | Appearance | Excellent | Good | Excellent | Excellent | Excellent | Excellent | Excellent | Excellent | Excellent | Excellent |
| | Bleed-out | Excellent | Excellent | Excellent | Excellent | Good | Excellent | Good | Good | Excellent | Excellent |

TABLE 2

| | | | Example | Example | Example | Comp. | Comp. | Comp. | Comp. | Comp. | Comp. |
|---|---|---|---|---|---|---|---|---|---|---|---|
| | | | 11 | 12 | 13 | Ex. 1 | Ex. 2 | Ex. 3 | Ex. 4 | Ex. 5 | Ex. 6 |
| Composition | PBAT | | 100 | 100 | 100 | 100 | 100 | 100 | 100 | 100 | 100 |
| (parts by | Aliphatic | B-1 | 5 | 5 | 5 | | | | | 15 | |
| mass) | polyester | B-2 | | | | | | | | | |
| | | B-3 | | | | | | | | | 15 |

| | | | | | | | | | | |
|---|---|---|---|---|---|---|---|---|---|---|
| | Aliphatic ester | 1 | 2 | 2 | | 2 | 3 | 3 | | |
| | compound | | | | | | | | | |
| | Phosphate metal | | | 0.5 | | | | 0.5 | | |
| | salt | | | | | | | | | |
| Evaluation | Melt viscosity | Excellent | Excellent | Excellent | Poor | Poor | Poor | Poor | Excellent | Excellent |
| | Crystallization | 71 | 71 | 79 | 38 | 71 | 72 | 79 | 68 | 68 |
| | temperature | | | | | | | | | |
| | Appearance | Excellent | Excellent | Excellent | Poor | Poor | Poor | Poor | Poor | Poor |
| | Bleed-out | Excellent | Excellent | Excellent | Excellent | Excellent | Excellent | Excellent | Poor | Poor |

As shown in Tables 1 and 2, resin compositions containing an aliphatic polyester having a specific structure with respect to 100 parts by mass of PBAT had low melt viscosity at 200° C. (Examples 1 to 13). In these Examples, the crystallization temperature was 69° C. or more, and molding could be performed in a relatively short time.

On the other hand, when the amount of an aliphatic polyester having a specific structure exceeds 10 parts by mass with respect to 100 parts by mass of PBAT, bleed-out is more likely to occur (Comparative Examples 5 and 6). In addition, resin compositions including no aliphatic polyester resin had increased melt viscosity at 200° C. (Comparative Examples 1 to 4).

This application is entitled to and claims the benefit of Japanese Patent Application No. 2020-077697 filed on Apr. 24, 2020, the disclosure of which including the specification and drawings is incorporated herein by reference in its entirety.

### INDUSTRIAL APPLICABILITY

The resin composition of the present invention can be buried in soil or composted after the use without imposing a burden on the environment. In addition, a molded article can be efficiently produced from the resin composition. Therefore, the resin composition can be used in a wide variety of applications such as drip irrigation tubes (such as emitters and tubes) and various packaging members.

### REFERENCE SIGNS LIST

100 Drip irrigation tube
110 Tube
111 Discharge port
112 Inner wall surface
120 Emitter
120a First main body
120b Second main body
123 Hinge
131 Intake part
132 Groove
136 Flow rate adjusting part
137 Discharge part
142 Channel
146 Intake side screen part
147 Intake through hole
150 Notched groove
151 Communication hole
153 Diaphragm part
161 Base
162 Communicating groove

What is claim is:

1. A resin composition, comprising:
100 parts by mass of poly(butylene adipate/terephthalate); and
1 to 10 parts by mass of an aliphatic polyester represented by general formula 1 below: 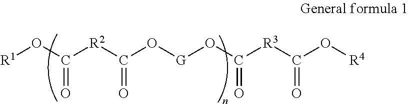
wherein, in general formula 1, R¹ and R⁴ each represent an alkyl group having 1 to 12 carbon atoms, R² and R³ each represent an alkyl group having 2 to 5 carbon atoms, G represents an alkyl group having 2 to 12 carbon atoms, and n represents an integer of 2 to 10,
wherein
an amount of poly(butylene adipate/terephthalate) is 80 mass % or more based on a total mass of the resin composition.

2. The resin composition according to claim 1, further comprising:
5 parts by mass or less of an aliphatic ester compound having a structure derived from a fatty acid having 2 to 5 carbon atoms.

3. The resin composition according to claim 1 or 2, further comprising:
5 parts by mass or less of a phosphate metal salt represented by general formula 2 below: 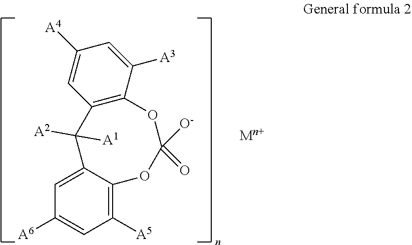
wherein, in general formula 2, Al and A² each represent a hydrogen atom or an alkyl group having 1 to 4 carbon atoms, A³ to A⁶ each represent an alkyl group having 1 to 12 carbon atoms, M represents at least one metal atom selected from the group consisting of alkali metal atoms, alkaline earth metal atoms, and transition metal atoms, and n represents an integer of 1 or 2.

4. An emitter for discharging an irrigation liquid in a tube at a constant amount from a discharge port to an outside of the tube when the emitter is joined to an inner wall surface of the tube at a position corresponding to the discharge port, the tube allowing the irrigation liquid to flow therethrough, the discharge port allowing an inside and the outside of the tube to communicate with each other, the emitter comprising:
an intake part for taking the irrigation liquid into the emitter;
a discharge part for discharging the irrigation liquid to the discharge port; and
a channel connecting the intake part and the discharge part,
wherein the emitter contains the resin composition according to claim 1.

5. A drip irrigation tube, comprising:
a tube; and
the emitter according to claim 4 disposed in the tube of the drip irrigation tube.

6. The drip irrigation tube according to claim 5, wherein
the tube of the drip irrigation tube contains the resin composition according to claim 1.
